(19) United States
(12) Patent Application Publication
(10) Pub. No.: US 2026/0292558 A1
(43) Pub. Date: Sep. 24, 2026

(54) USER SELECTION FOR COORDINATED BEAMFORMING AND COORDINATED SPATIAL REUSE

(71) Applicant: Samsung Electronics Co., Ltd., Gyeonggi-do (KR)

(72) Inventors: Yongsen MA, Milpitas, CA (US); Eunsung JEON, Gyeonggi-do (KR); Srinivas KANDALA, Morgan Hill, CA (US)

(21) Appl. No.: 19/569,083

(22) Filed: Mar. 17, 2026

Related U.S. Application Data
(60) Provisional application No. 63/775,550, filed on Mar. 21, 2025.

(51) Int. Cl. H04W 24/08; H04B 7/024

(52) U.S. Cl. CPC H04W 24/08; H04B 7/024

(57) ABSTRACT

A method, station and system are disclosed for user selection for coordinated beamforming (Co-BF) and coordinated spatial reuse (Co-SR). The method, station, and system receive, from an access point (AP), by a station (STA) not associated with the AP, a frame and measure, with the STA, an overlapping basic service set (OBSS) received signal strength indicator (RSSI) based on the frame received from the AP. The method, station, and system also transmit, by the STA, information based on the OBSS RSSI measurement.

### CROSS-REFERENCE TO RELATED APPLICATION

This application claims the priority benefit under 35 U.S.C. § 119(e) of U.S. Provisional Application No. 63/775,550, filed on Mar. 21, 2025, the disclosure of which is incorporated by reference in its entirety as if fully set forth herein.

### TECHNICAL FIELD

The disclosure generally relates to coordinated beamforming (Co-BF) and coordinated spatial reuse (Co-SR). More particularly, the subject matter disclosed herein relates to improvements to user selection for Co-BF and Co-SR.

### SUMMARY

In wireless networks, an access point (AP) can serve as a hub for a plurality of wireless network devices referred to as stations (STAs). The STAs are typically within a service area of an associated AP. The STAs may be fixed, mobile, semi-fixed, etc. The STAs may be communicatively coupled with at least the associated AP. That is, a given STA may be associated with only one AP but can communicate with non-associated APs. In addition, the STAs associated with a given AP typically do not communicate directly with each other within the wireless network. However, the STAs may have additional wireless features, such as Bluetooth, non-AP based wireless fidelity (Wi-Fi) networks, ad hoc mesh networks, etc. A given STA can be in a service area of two or more APs. For example, an STA may be in a first service area associated with a first AP (AP1), a second service area associated with a second AP (AP2), and/or etc.

FIG. 1 is a schematic diagram of a system 100 including an overlapping basic service set (OBSS) between AP1 and AP2 according to an embodiment. The system 100 may include users selected for Co-BF and Co-SR based on an OBSS received signal strength indicator (RSSI) measurement.

Referring to FIG. 1, six STAs are shown by way of example, where four of the STAs are located in service areas associated with both AP1 and AP2. Associations between the six STAs and their respective APs are illustrated as comm-links depicted by lightning bolts. As shown in FIG. 1, the STA1, STA2, and STA5 may be associated with AP1. In addition, STA3, STA4, and STA6 are shown as associated with AP2. The STA1, STA2, STA3, and STA4 are in an overlapping service area.

It should be appreciated that standards may use differing terms for similar functions. Accordingly, “access point” or “AP” may be used interchangeably with other terms, such as a “base station,” “station functioning as an access point,” etc. As described herein, a wireless network of an AP and its associated STAs can be referred to as a basic service set (BSS). The term “OBSS” can refer to wireless networks that partially overlap. From a geographic perspective, the OBSS can be viewed as overlapping service areas.

An AP can be any configuration of hardware and software comprising a backhaul equipment for connecting to a wired network, a baseband processor for signal processing of a baseband signal, a modulating unit to modulate and demodulate between the baseband signal and a wireless signal (e.g., received or to be transmitted), and an antenna array that transmits and receives the transmission signal. The antenna array may include a plurality of antennas collectively capable of shaping the antenna's radiation patterns into directional communication beams using, for example, constructive interference between signals emitted by radiating elements of the arrays.

Various transmission modes may be employed for intra-BSS and OBSS STAs, including Co-BF and Co-SR, multi-user (MU)-multiple input, multiple output (MIMO), and/or single user (SU)-MIMO. Co-BF includes the use of beamforming by two APs to transmit to a single STA. Co-SR includes the adjustment of power levels between two APs to reduce any undesirable interference.

The Co-BF/Co-SR may allow the APs of OBSSs to coordinate their respective transmissions to a given STA. For example, with reference to FIG. 1, the AP1 and AP2 may coordinate their transmissions to each of the STA1 through STA4. However, the AP1 and the AP2 may or may not be able to coordinate their transmissions to the STA5 and STA6, depending on specific coordination scheme and the intra-BSS and the OBSS RSSI of each STA.

Accordingly, AP1 may not be able to detect/decode the frames from the STA6 and the AP2 may not be able to detect/decode the frames from the STA5. In addition, the AP1 may cause interference at the STA3 and STA4 and the AP2 may cause interference at the STA1 and STA2. It should also be appreciated that the STA5 may not hear AP2 and the STA6 may not hear the AP1 due to not being in the OBSS for the arrangement shown in FIG. 1.

Therefore, STA5 and STA6 may be viewed as being effective for Co-SR because suitable power levels are likely, but not effective for Co-BF because simultaneous beamforming from both AP1 and AP2 to either STA5 or STA6 may not be feasible. For example, AP1 may not be able to perform sounding or frame exchanges with STA6 and AP2 may not be able to perform sounding or frame exchanges with STA5. Attempting to perform Co-BF with STA5 and STA6 may introduce extra overhead, complexity, and error detection/recovery. In contrast, STA1/2 and STA3/4 may be viewed as being suitable for Co-BF but less suitable for Co-SR. For example, performing Co-SR with each of STA1/2 and STA3/4 may introduce interference and performance degradation.

To address this type of problem, each AP may select the suitable STAs for participating in Co-BF/Co-SR. For Co-BF, an AP may detect/decode OBSS transmissions such as initial control frame (ICF)/initial control response (ICR), multi-user block access request (MU-BAR)/block access (BA), cross-BSS CSI, and/or the like, if frame detection/decoding between AP and unassociated STAs is needed. Otherwise, OBSS frame detection/decoding errors may occur, or a given AP may not be aware of OBSS failures. These and other similar failures can lead to higher overhead/complexity and lower performance.

For Co-SR, each AP may need to have proper transmit (Tx) power control and/or receive (Rx) sensitivity control to reduce OBSS interference. Each AP may also need to select a suitable acknowledgement (ACK) mechanisms/parameters depending on whether the AP can hear the ACK/BA from cross-BSS STAs. Otherwise, low intra-BSS signal quality, high OBSS interference, or collisions/interference for an ACK/BA can also lead to higher overhead/complexity and lower performance.

To overcome these types of issues, systems and methods are described herein for user selection for Co-BF and Co-SR based on OBSS RSSI measurements. Performing such user selection may improve on previous methods because including the OBSS RSSI can help select the most suitable Co-BF/Co-SR STAs, reduce interference, overhead, and/or complexity, and improve performance and efficiency.

In an embodiment, a method comprises receiving, from an AP, by an STA not associated with the AP, a frame, measuring, with the STA, an OBSS RSSI based on the frame received from the AP, and transmitting, by the STA, information based on the OBSS RSSI measurement.

In an embodiment, an STA comprises a radio and a processing circuit communicatively coupled with the radio, the processing circuit being configured to receive, via the radio, a frame transmitted by an AP to be measured by STA, measure an OBSS RSSI based on the frame received via the radio, and transmit information based on the OBSS RSSI measurement.

In an embodiment, a system comprises an AP1 and an AP2 communicatively coupled with each other. The AP2 is configured to transmit a frame to be measured by a STA not associated with the AP2. The AP1 is configured to receive from the STA at least one of an indication that the STA intends to be a candidate Co-BF/Co-SR STA or an OBSS RSSI report based on the frame to be measured by the STA.

### BRIEF DESCRIPTION OF THE DRAWINGS

In the following section, the aspects of the subject matter disclosed herein will be described with reference to exemplary embodiments illustrated in the figures, in which:

FIG. 1 is a schematic diagram of a system 100 including an OBSS between AP1 and AP2 according to an embodiment;

FIG. 2 is a sequence diagram 200 of a user selection for Co-BF/Co-SR based on an OBSS RSSI measurement according to an embodiment;

FIG. 3 shows a method 300 for a user selection for Co-BF/Co-SR based on an OBSS RSSI measurement according to an embodiment;

FIG. 4 shows a method 400 for a user selection for Co-BF/Co-SR based on an OBSS RSSI measurement according to an embodiment;

FIG. 5 shows a block diagram of an electronic device in a network environment 500, according to an embodiment; and

FIG. 6 shows a system 600 including an AP1 610, an AP2 620, and an STA 630.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The quality of a transmission between an AP and an STA can be encapsulated in a channel state information (CSI) report. A CSI report may include information on the physical layer (PHY) measurements of the condition of a transmission channel. The CSI report can contain information related to fading, scattering, power decay, etc. of a signal propagating through the transmission channel. The CSI report may be based on statistical, instantaneous, or similar determined values. The CSI reports can be based on channel state estimation procedures that use, for example, a CSI reference signal (e.g., pilot) sent over the channel. The CSI report may indicate how well an STA will receive a signal transmitted by an AP.

The CSI reference signals may be used in sounding techniques. The sounding techniques may involve an AP sending the reference signal to an STA and the STA subsequently responding with information on how well the STA received the reference signal. For example, the reference signal may comprise a training signal (e.g., short training fields, long training fields, etc.) of known sequences transmitted on orthogonal frequency division multiplexing (OFDM) subcarriers. The training signal can be transmitted by an AP during sounding of an STA. Accordingly, sounding may refer to sending a training signal over a particular transmission channel, such as between transmit and receive antennas, to generate a CSI report about the transmission channel.

At least two types of sounding may be employed: sequential sounding and joint sounding. In sequential sounding, the training signals may be sent over different transmission channels at different times and/or frequencies to a given STA. In joint sounding, the training signals can be sent simultaneously from multiple APs to an STA. The STA can measure the training signals from the multiple APS. The STA may respond simultaneously with information about how well the training signals were heard. Joint sounding can be more efficient than sequential sounding.

The terms “intra-BSS” and “cross-BSS” can be used to distinguish transmissions between an AP and associated STAs from transmissions between the AP and non-associated STAs. For example, a reference signal transmitted by an AP to an associated STA may be referred to as an intra-BSS reference signal. Conversely, a reference signal transmitted from an AP to a non-associated STA may be referred to as a cross-BSS reference signal. Accordingly, training signals sent by an AP to associated and non-associated STAs can respectively be referred to as intra-BSS sounding and cross-BSS sounding.

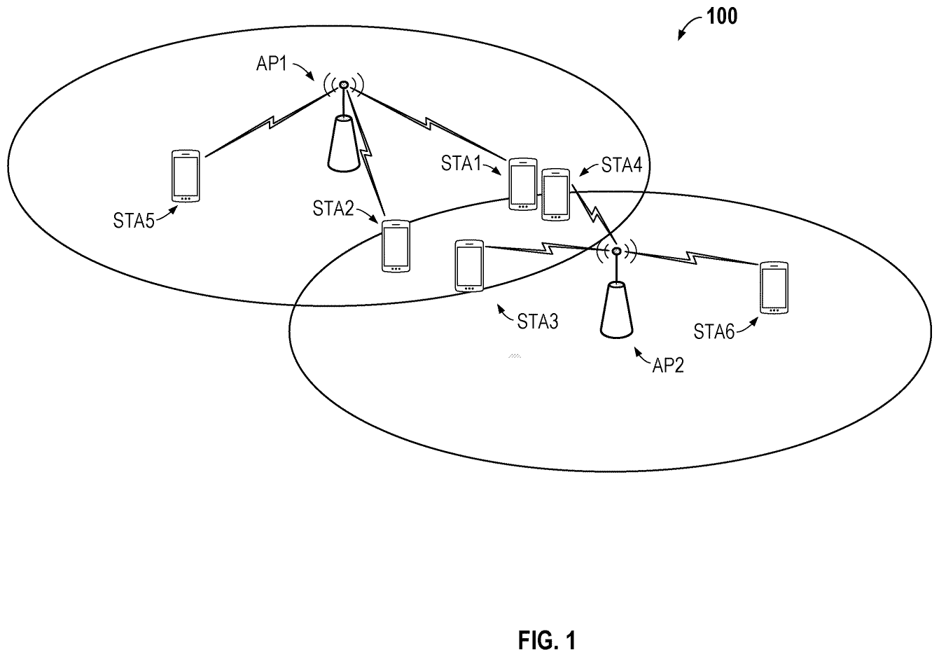

With reference to FIG. 1, the STAs in the OBSS may be sounded with intra-BSS and cross-BSS training signals transmitted by the two APs. The STA receiving intra-BSS and the cross-BSS sounding may accordingly provide an intra-BSS and a cross-BSS CSI report via a CSI feedback to an associated AP. The AP receiving the CSI reports can provide the cross-BSS CSI and/or the intra-BSS CSI reports to the other AP.

The cross-BSS CSI reports can be used by the APs in Co-BF/Co-SR procedures. The Co-BF/Co-SR procedures may be defined in a specification. For example, the Institute of Electrical and Electronics Engineers (IEEE) P802.11bn/D0.1 standard may define explicit feedback mechanisms, such as the Ultra High Reliability Trigger Based (UHR TB) sequential/joint null data packet (NDP) sounding, for intra-BSS sounding and cross-BSS sounding to measure and report the CSI. These CSI reports can be used to enable concurrent transmissions from two APs to each AP's associated STAs while minimizing interference to cross-BSS/OBSS STAs.

For example, the Co-BF procedures can enable concurrent transmissions with beamforming and carrier frequency synchronization. For example, beamforming by an AP can ensure constructive interference of the AP's transmissions at an intended STA and destructive interference of the AP's transmissions at an unintended STA. In addition, carrier frequency synchronization can ensure that transmissions from two APs to an STA are constructively interfering at the intended STA. In addition, the Co-SR procedures can ensure that appropriate power levels are selected for the transmissions to ensure reliable transmissions from an AP to an intended STA while also minimizing the interference at unintended STAs.

When employing Co-SR, APs may share a given channel by controlling power and timing to allow simultaneous transmissions by reducing interference. For Co-SR, the APs talk to each other to understand channel conditions and nearby transmissions. An AP taking a transmission opportunity (TxOP) may inform APs who may reduce their transmit power or remain silent to avoid interfering with the AP's transmission. Co-SR may be used to reduce interference by manipulating beamforming and signal strength to reduce interference in a given channel.

When employing Co-BF, two APs may simultaneously transmit frames to given STAs. The frames transmitted during Co-BF may be sounding frames, data frames, etc. The two APs perform beamforming simultaneously to ensure a sufficiently high signal strength for intra-BSS STA(s) and a sufficiently low interference for cross-BSS STA(s), so intra-BSS STA(s) can receive and process the frames while cross-BSS STA(s) can avoid interference. Co-BF can also be employed during sounding to, for example, determine a channel matrix characterizing channels between the two APs and both intra-BSS STA(s) and cross-BSS STA(s).

A RSSI may be based on, for example, a power level of a beacon frame, a preamble of a physical layer (PHY) frames, etc. The beacon frames may be used for other purposes, such as a primary mechanism for AP discovery and initial signal strength assessment. Signal strength can be measured and represented in various units, such as, for example, decibel-milliwatts (dBm). The dBm scale is a logarithmic unit measuring the absolute power level relative to 1 milliwatt (mW). The value of 0 dBm is equivalent to a signal strength of 1 mW. Additionally, or alternatively, other units related to signal strength may be employed.

The following are two tables summarizing relationships between the APs and the STAs shown in FIG. 1.

TABLE 1
OBSS relationships

| | |
|---|---|
| STA1/2 | STA3/4 |

| Relative | Relative | Relative | Relative |
|---|---|---|---|
| to AP1 | to AP2 | to AP1 | to AP2 |
| Associated | Non-associated | Non-associated | Associated |
| Intra-BSS | Cross- | Cross- | Intra-BSS |
| | BSS/OBSS | BSS/OBSS | |
| Beacon/ | Beacon/ | Beacon/ | Beacon/ |
| Request | Request | Request | Request |

TABLE 2
Non-OBSS relationships

| | |
|---|---|
| STA5 | STA6 |

| Relative | Relative | Relative | Relative |
|---|---|---|---|
| to AP1 | to AP2 | to AP1 | to AP2 |
| Associated | Non-associated | Non-associated | Associated |
| Intra-BSS | Cross-BSS | Cross-BSS | Intra-BSS |
| Beacon/ | No frames | No frames | Beacon/ |
| Request | received | received | Request |

The OBSS relationships Table 1 includes an STA1/2 set of columns and an STA3/4 set of columns. Within the STA1/2 and the STA3/4 set of columns are relationships to AP1 and relationships to AP2. The non-OBSS Table 2 includes an STA5 set of columns and an STA6 set of columns.

According to Table 1, the OBSS relationships show that AP1 and STA1/2 are associated, intra-BSS, and can perform the user selection for Co-BF and Co-SR based on either a beacon or a request. Similarly, the relationships between the STA3/4 and AP2 shown in Table 1 and, referring to Table 2, between the STA5 and the AP1 and the STA6 and the AP2 associated, intra-BSS, and can use beacons or a request/response exchange. Referring again to Table 1, the STA1/2 and the AP2 relationships and the STA3/4 and AP1 relationships may be non-associated, cross-BSS, and can use beacons or a request/response frame. Referring to Table 2, the relationships between the STA5 and the AP2 and between the STA6 and the AP1 may be similar as being non-associated, cross-BSS, but may not include, for example, a frame exchange.

As will be explained in more detail in the following, User selection can be done with different kinds of measurement modes, such as passive/active and different frames (e.g., beacon/request). APs/STAs have the choice to select different request/measurement/report methods. There may be several steps/components. In an OBSS/RSSI request, an AP sends a request frame to STAs to request the STA to measure RSSI and to report the measured RSSI back to the AP.

During the OBSS/RSSI, the AP may request an active or passive measurement mode. When an active measurement mode is requested, the STA may send a probe request (or other frames) to another AP. The other AP can respond with probe response (or other frames). The STA may use the response from the other AP to measure the OBSS RSSI. During a passive measurement, an STA may listen to the frames, e.g., beacon, from the other AP. The STA measures the OBSS RSSI based on the frames from the other AP.

An STA may perform OBSS RSSI measurements using different types of frames depending on the measurement mode (active/passive). After the measurement, the STA may have the RSSI measurement and can send the RSSI report to the AP. The STA can send the measured RSSI in a frame (e.g., a Beacon Report) to the AP. After the report, the AP now can use the measured RSSI from different STAs to perform user selection.

Each AP can use the OBSS RSSI reports to select candidate users/STAs to perform Co-BF/Co-SR. Based on user selection result, APs may perform Co-SR/Co-BF data transmissions. Before a Co-BF data transmission, there may also be a sounding procedure to measure the CSI for each AP and both in-BSS STA and cross-BSS STA. For an OBSS RSSI measurement, the frames are between the STA and unassociated AP (and hence the name OBSS RSSI). For other steps, the frames may be between the STA and associated AP for information exchange but may not be for the actual RSSI measurement.

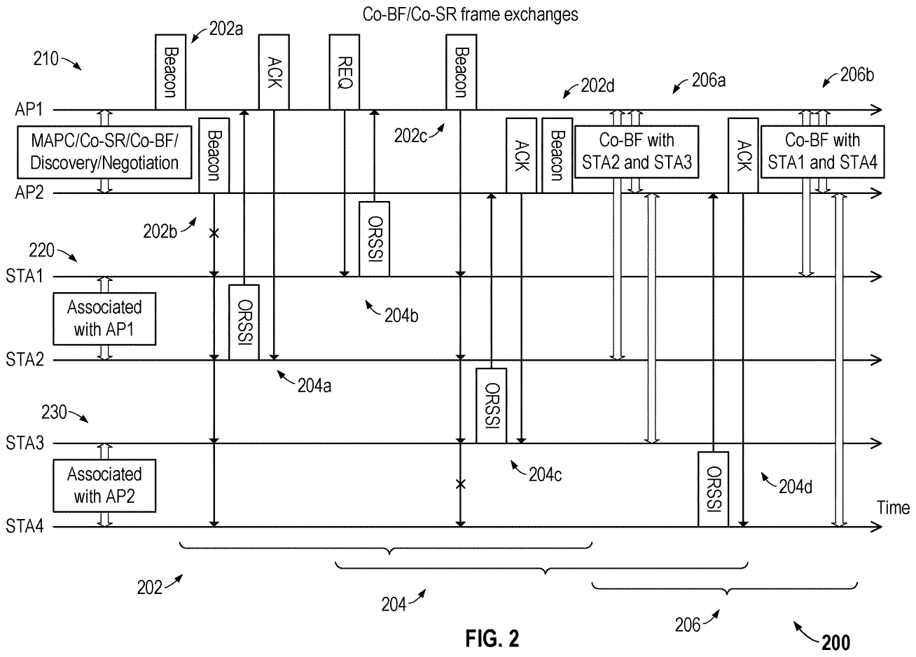

FIG. 2 is a sequence diagram 200 of a user selection for Co-BF/Co-SR based on an OBSS RSSI measurement according to an embodiment. The sequence diagram 200 may be for passive OBSS RSSI measurements where an STA does not make a request and measures beacons transmitted by the AP1 and AP2.

Referring to FIG. 2, the sequence diagram 200 includes AP1/AP2 sequence lines 210, STA1/STA2 sequence lines 220, and STA3/STA4 sequence lines 230. The AP1/AP2 sequence lines 210 include the AP1 and AP2 sequence lines to indicate which AP is transmitting or receiving. Similarly, the STA1/STA2 sequence lines 220 and the STA3/4 sequence lines 230 respectively indicate whether the corresponding STA is transmitting or receiving. Adjacent the AP1/AP2 sequence lines 210, STA1/STA2 sequence lines 220, and STA3/STA4 sequence lines 230 are blocks indicating a transmission by the corresponding AP or STA, depending on the most proximate line or both if the block is equidistant from each line.

The transmissions indicated by the blocks are shown as grouped by beacon transmissions 202, OBSS RSSI exchanges 204, and a Co-BF/Co-SR transmissions 206. The beacon transmissions 202, the OBSS RSSI exchanges 204, and the Co-BF/Co-SR transmissions 206 overlap in sequence. The beacon transmissions 202 is shown as including a first through fourth beacon 202a-202d. The OBSS RSSI exchanges 204 includes a first through fourth OBSS RSSI exchange 204a-d. The Co-BF/Co-SR transmissions include an STA2/3 Co-BF 206a and an STA1/4 Co-BF 206b.

The first through fourth beacons 202a-202d are shown as being transmitted at roughly equal intervals from the AP1 And AP2. With more particularity, the first and second beacon 202a, 202b are shown as being transmitted, respectively, from AP1 and AP2 in close sequence or about the same time. At a time interval later the third and fourth beacon 202c, 202d are shown as being transmitted, respectively, from AP1 and AP2. The first and fourth beacon 202a, 202d are shown without transmissions arrows to indicate that the respective beacon may have reached all of the depicted STAs. The second and third beacon 202b, 202c are shown as including transmission lines to the STAs where an ineffective transmission (e.g., unreachable, RSSI signal strength is below a certain threshold, etc.) is indicated with an “X.” With more particularity, the second beacon 202b did not effectively transmit from the AP2 to STA1 and the third beacon 202c did not effectively transmit from the AP1 to the STA4, but did reach to other STAs.

The first through fourth OBSS RSSI exchange 204a-204d may include a request (REQ) transmitted from an AP to an STA, an OBSS RSSI transmissions from an STA to an AP, and/or an acknowledgement (ACK), depending on whether the beacon or a REQ is utilized. For example, in the first OBSS RSSI exchange 204a, the STA2 transmits an OBSS RSSI to AP1. The AP1 may respond with an ACK. The second OBSS RSSI exchange 204b may include a REQ for an OBSS RSSI transmitted by the AP1. In response, the STA1 may transmit an OBSS RSSI to the AP1. The third OBSS RSSI exchange 204c may include an OBSS RSSI transmitted from the STA3 to the AP2. The AP2 may respond with an ACK. The fourth OBSS RSSI exchange 204d may be comprised of an OBSS RSSI transmitted by STA4 to the AP2. The AP2 may respond with an ACK.

The first and third OBSS RSSI exchange 204a, 204c may be based on a beacon transmitted by the AP1 or the AP2. For example, the first OBSS RSSI exchange 204a may be based on the second beacon 202b transmitted by the AP2. The third OBSS RSSI exchange 204c may be based on the third beacon 202c transmitted by the AP1.

Accordingly, the OBSS RSSI of the first OBSS RSSI exchange 204a may be based on measurements of a beacon transmitted by AP2 and received by the STA2, STA3, and STA4, but not the STA1. For example, the STA1 may not be within the range of the beacon transmitted by the AP2 at the time of the first OBSS RSSI exchange 204a.

The second OBSS RSSI exchange 204b may be based on a REQ transmitted by the AP1. For example, as discussed above, the second beacon 202b may not be received by the STA1. Accordingly, the AP1 may initiate the second OBSS RSSI exchange 204b to obtain the OBSS RSSI from the STA1 by transmitting the REQ to the STA1. Because the second beacon 202b may not be received by the STA1, the OBSS RSSI transmitted by the STA1 may include a predetermined value, such as 255 or 0.

Similar to the first OBSS RSSI exchange 204a, the third OBSS RSSI exchange 204c may be based on the third beacon 202c transmitted by the AP1. The third beacon 202c may be received by the STA1 through STA3 but not the STA4. Accordingly, the AP2 may not have an OBSS RSSI from the STA4 after the third OBSS RSSI exchange 204c.

The fourth OBSS RSSI exchange 204d may be initiated by STA4 after the STA2/3 Co-BF 206a. With more particularity, the fourth beacon 202d may be transmitted before the STA2/3 Co-BF 206a and received by the STA4, along with the other STAs. During the fourth OBSS RSSI exchange 204d, the STA4 may transmit an OBSS RSSI to the AP2 based on the fourth beacon 202d. In response, the AP2 may transmit an ACK to the STA4.

As described above with reference to FIG. 1, STA1 and STA2 may not be associated with AP2 and STA3 and STA4 may not be associated with AP1 and thus can be referred to as STAs not associated with the non-associated AP. If an STA lies within an OBSS then the non-associated AP may be referred to as an OBSS AP. Accordingly, as shown in FIG. 2, a STA can measure an OBSS RSSI from an OBSS AP, which may be the other Co-BF/Co-SR AP when used for Co-BF/Co-SR.

An STA may measure the OBSS RSSI using passive or active measurements. As described above, FIG. 2 is an example of passive measurements. In passive measurements, an STA can measure an OBSS RSSI using a beacon, NDP, Co-BF (Sounding) Response, Co-SR Response frames, etc., from the OBSS AP. The active measurements may be when a STA sends a request frame (e.g., a probe request frame) to an OBSS AP and measures an OBSS by a response frame (e.g., a probe response frame).

The request/response frame exchange can include a Probe Request/Probe Response, request-to-send (RTS)/clear-to-send (CTS), NDP announcement (NDPA)/NDP, etc. Due to the overhead of a request/response exchange, it may be desirable to avoid frequent/unintended requests. The passive measurements may be considered low overhead due to, for example, not requiring the request/response exchange.

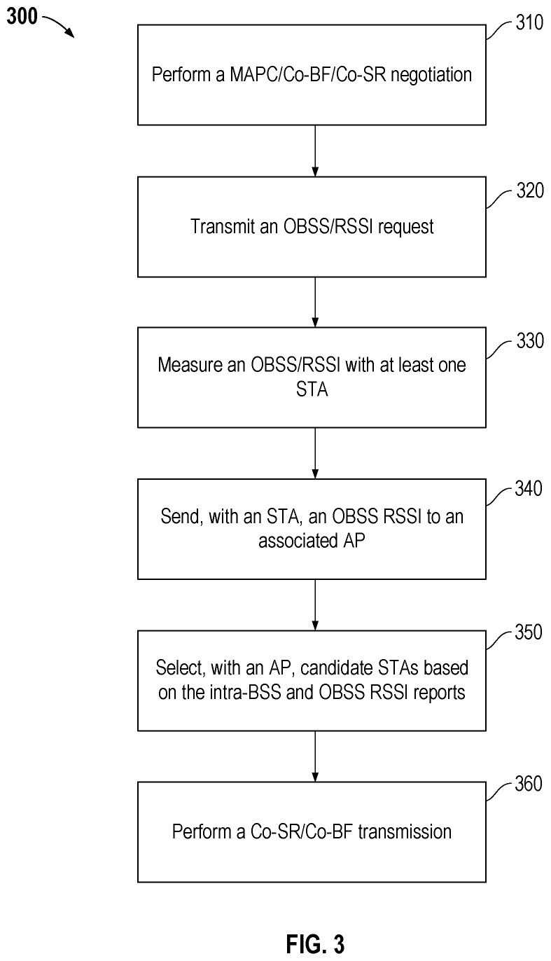

FIG. 3 shows a method 300 for a user selection for Co-BF/Co-SR based on an OBSS RSSI measurement according to an embodiment.

Referring to FIG. 3, the method 300 may perform a multi-access point coordination (MAPC)/Co-SR/Co-BF negotiation in step 310. The method 300 can transmit an OBSS/RSSI request in step 320. In step 330, the method 300 can measure an OBSS RSSI with at least one STA. The method 300 can also send, with an STA, an OBSS RSSI to an associated AP in step 340. More than one STA may send their respective OBSS RSSI. In step 350, the method 300 can select, with APs, candidate STAs based on intra-BSS and OBSS RSSI reports of the STAs. The method 300 can perform Co-SR/Co-BF transmission.

With reference to the system 100 of FIG. 1, during the MAPC/Co-SR/Co-BF negotiations of step 310, AP1 and AP2 may communicate with each other to coordinate transmission of frames for OBSS RSSI measurements.

In step 320, an OBSS/RSSI request can specify an active or passive measurement mode. When an active mode is requested, the STA may send a probe request or other frames to another AP not associated with the STA. The other AP can respond with a probe response or other frames. The STA may use the other AP's response to measure the OBSS RSSI. If a passive mode is requested then STA may listen for frames, such as beacon frames, from the other AP. The STA can measure the OBSS RSSI based on the frames from the AP.

In step 330, the at least one STA may only monitor OBSS RSSI of selected APs. Signaling may be employed if and when an STA may not be able to hear OBSS frames. It should be appreciated that the passive/active RSSI measurements may overlap with other phases like sounding, data transmissions, etc.

In step 340, an STA that performed the measurement can send an OBSS RSSI to an associated AP. For example, with reference to the system 100 of FIG. 1, the STA2 may send an OBSS RSSI to the AP1 after measuring a frame transmitted by the AP2. The AP1 may forward the OBSS RSSI to the AP2.

The method 300, in step 350, may be employed by an STA and/or an AP to determine that the STA is suitable as a candidate Co-BF/Co-SR STA. For example, referring to FIG. 1, where the STA2 sent an OBSS RSSI to an AP1, the AP1 may determine that the STA2 is a candidate Co-BF/Co-SR STA.

In step 360, the method 300 can perform the Co-SR/Co-BF based on the determination that the STA is suitable as a candidate Co-SR/Co-BF STA.

As described herein, user selection for Co-BF/Co-SR based on OBSS RSSI measurements may be performed. An STA may measure OBSS RSSI from the OBSS AP (the other Co-BF/Co-SR AP), either passively by Beacons from the OBSS AP or actively by sending request frame, such as Probe Request, RTS, NDPA, and NDP, and measuring the OBSS RSSI by the response frame, such as Probe Response, CTS, and NDP. The OBSS RSSI measurements can be used for user selection for Co-BF/Co-SR. The STA may report the OBSS RSSI measurements to its associated AP, and the AP selects the candidate STA for Co-BF/Co-SR, or for other purposes such as roaming. The STA may determine its intention to be a candidate Co-BF/Co-SR STA based on the in-BSS/OBSS RSSI measurements and sends the indication to its associated AP. It can coexist with other criteria/ways for selecting candidate Co-BF/Co-SR STAs. It helps UHR APs select the suitable STAs to participate in Co-BF/Co-SR, reduce interference/overhead/complexity during sounding and Co-BF/Co-SR data transmission phases, and improve performance gains.

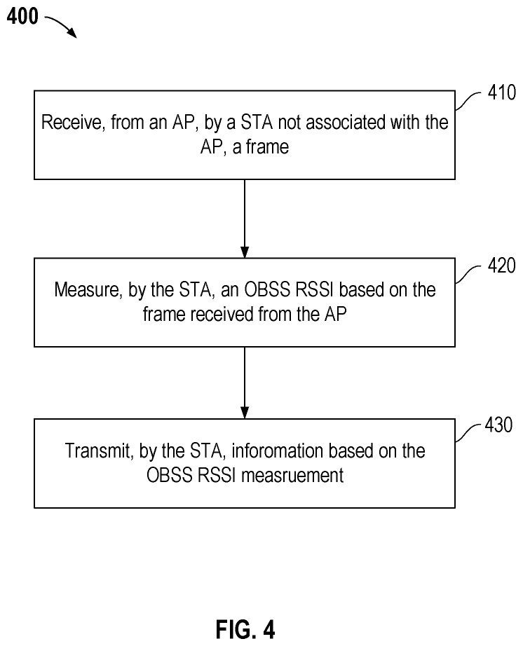

FIG. 4 is a method 400 for a user selection for Co-BF/Co-SR based on an OBSS RSSI measurement according to an embodiment.

Referring to FIG. 4, the method 400 can receive, from an AP, by an STA not associated with the AP, a frame in step 410. In step 420, the method 400 can measure, by the STA, an overlapping basic service set OBSS RSSI based on the frame received from the AP. The method 400, in step 430 can transmit, by the STA, information based on the OBSS RSSI measurement.

The method 400 can further comprise transmitting, by the STA, to the AP, a request frame requesting that the AP transmit the frame to the STA. Transmitting, by the STA, the request frame requesting that the AP transmit the frame to the STA can comprise transmitting, by the STA, one of a probe request frame, a RTS frame, or an NDPA frame. The frame transmitted by the AP to the STA may comprise a response frame transmitted in response to the request frame transmitted by the STA, the response frame being one of a probe response frame, a CTS frame, or an NDP frame.

The step 410 of receiving, by the STA, the frame transmitted by the AP can comprise receiving, by the STA, one of a beacon frame, a NDP frame, a Co-BF sounding response frame, or a Co-SR response frame.

The method 400 can further comprise measuring, by the STA, an intra-BSS RSSI based on a frame transmitted by another AP associated with the STA. Additionally, or alternatively, the method 400 can further comprise determining, by the STA or another AP associated with the STA, that the STA is a candidate Co-BF/Co-SR STA. For example, the method 400 can further comprising transmitting, by the STA, to the another AP associated with the STA, an OBSS RSSI report including the information based on the OBSS RSSI measurement, wherein the another AP associated with the STA determines that the STA is the candidate Co-BF/Co-SR STA. Additionally, or alternatively, the method 400 can further comprise transmitting, by the STA, to the another AP associated with the STA, the information based on the OBSS RSSI by transmitting an indication that the STA is the candidate Co-BF/Co-SR STA, wherein the STA determines that the STA is the candidate Co-BF/Co-SR STA.

The OBSS RSSI measurements can be used for user selection for Co-BF/Co-SR. For example, an STA may report the OBSS RSSI measurements to its associated AP, and the AP can select the candidate STA for Co-BF/Co-SR. For example, with reference to FIG. 2, in the STA2/STA3 Co-BF 206a, the AP1 and the AP2 may respectively determine that the STA2 and the STA3 are the most suitable STAs for Co-BF/Co-SR. Additionally, or alternatively, an STA may determine its intention to be a candidate Co-BF/Co-SR STA based on intra-BSS and OBSS RSSI measurements performed by the STA.

It should be appreciated that the above-described processes can coexist with other criteria/ways for selecting candidate Co-BF/Co-SR STAs. The above-described processes can help UHR APs to select the suitable STAs to participate in Co-BF/Co-SR, reduce interference/overhead/complexity during sounding and Co-BF/Co-SR data transmission phases, and improve performance gains.

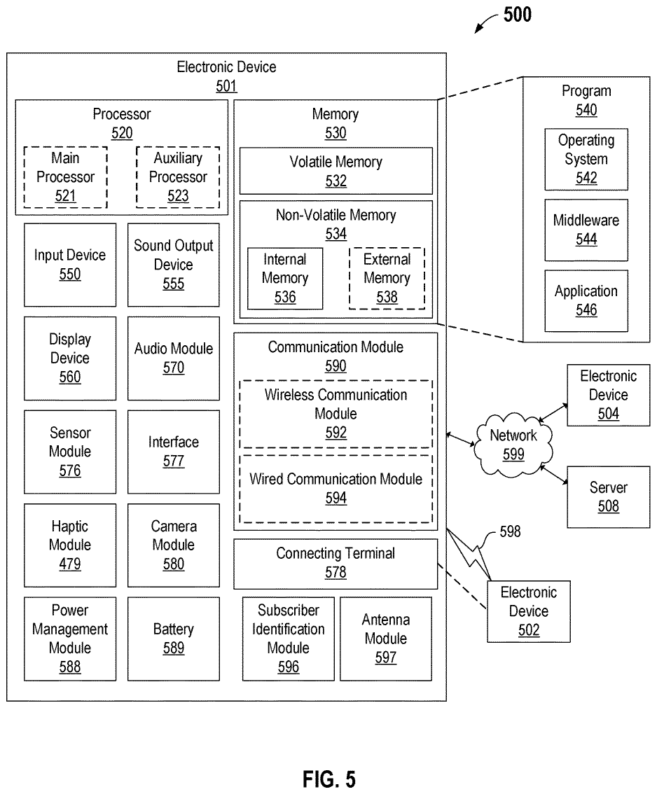

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (APr), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546. Accordingly, the processor 520 executing the program 540 may receive from an AP a frame and measure an OBSS RSSI based on the frame received from the AP. The processor 520 can also transmit information based on the OBSS RSSI measurement.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., an state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

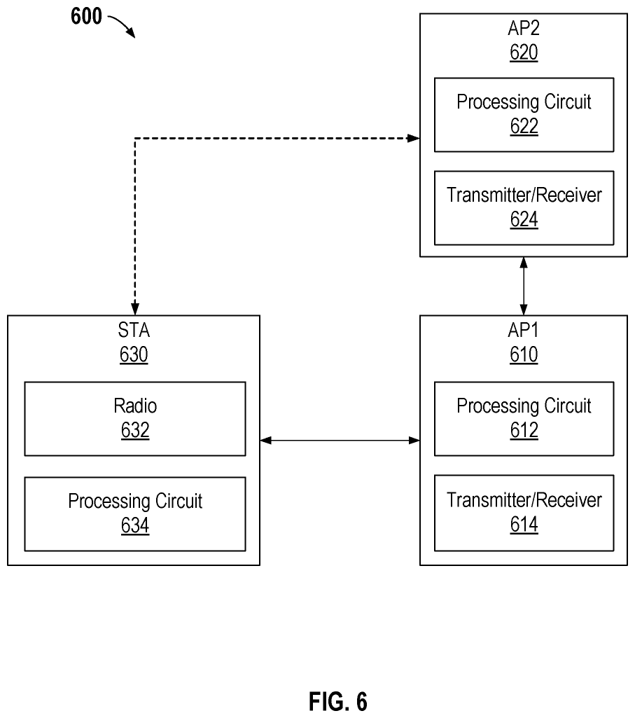

FIG. 6 shows a system 600 including an AP1 610, an AP2 620, and an STA 630.

Referring to FIG. 6, the AP1 610 is communicatively coupled with the STA 630 illustrated by a solid line. The AP1 610 may be communicatively coupled with the STA 630 via wireless uplinks and/or downlinks. The AP1 610 and the AP2 620 are also communicatively coupled with each other as is also illustrated by a solid line. The AP1 610 and the AP2 620 may be communicatively coupled with each other through backhaul connections, fronthaul wireless communications, and/or etc. The AP2 620 and the STA 630 are not shown as being communicatively coupled but instead include some transmissions, direct or indirect between the AP2 620 and the STA 630 as is illustrated by the dashed arrow line.

With reference to FIGS. 1 and 6, the AP1 610 and the STA 630 may be considered associated with each other and thus be part of a BSS. For example, the STA 630 and the AP1 610 may respectively be the STA2 and AP1 shown in FIG. 1. Accordingly, the BSS that includes the AP1 610 and the STA 630 shown in FIG. 6 may overlap with another BSS that includes the AP2 620 and thus may be an OBSS. The AP2 620 may therefore, for example, overhear communications between the AP1 610 and the STA 630 even though the AP2 620 may not be communicatively coupled with (e.g., associated with) the STA 630.

The AP1 610 and the AP2 620 may be any suitable combination of hardware and/or software that can provide wireless services to the STA 630. For example, the AP1 610 and the AP2 620 may respectively be comprised of a processing circuit 612, 622 and a transmitter/receiver 614, 624. The processing circuits 612, 622 may be any suitable combination of circuits, registers, code, and/or the like that can perform computations, such as, for example, those described herein. Additionally, or alternatively, the AP1 610 and the AP2 620 may be comprised of antennas (e.g., in one or more antenna arrays) for communications with, for example, the STA 630 and/or each other, a wired network interface to a router or switch, and/or the like. It should be appreciated that the term “access point” may be interchangeable with other terms such as “base station”, Next-Generation Node B (gNB), etc.

The STA 630 may include a radio 632 and a processing circuit 634. The radio 632 which may perform various methods disclosed herein. For example, the processing circuit 634 may receive, via the radio 632, transmissions from the AP1 610, and the processing circuit 620 may transmit, via the radio 632, signals to the AP1 610. Accordingly, the AP1 610 can transmit, for example, packets with or without data (e.g., symbols) via a transmission (e.g., across specific spatial stream) from the AP1 610 to the STA 630.

It should also be appreciated that the AP2 620 can also transmit to the STA 630 even though the AP2 620 and the STA 630 may not be associated. For example, the AP1 610 and/or the AP2 620 may transmit an NDPA to coordinate sequential and/or simultaneous transmissions from AP1 610 and/or AP2 620 to the STA 630 as is described in the foregoing. By way of illustration, based on the NDPA, the AP1 610 and/or the AP2 620 can transmit an NDP, simultaneously, sequentially, or individually, to the STA 630.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus.

Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, from an access point (AP), by a station (STA) not associated with the AP, a frame;
measuring, by the STA, an overlapping basic service set (OBSS) received signal strength indicator (RSSI) based on the frame received from the AP; and
transmitting, by the STA, information based on the OBSS RSSI measurement.

2. The method of claim 1, wherein receiving, by the STA, the frame transmitted by the AP comprises receiving, by the STA, one of a beacon frame, a null data packet (NDP) frame, a coordinated beamforming (Co-BF) sounding response frame, or a coordinated spatial reuse (Co-SR) response frame.

3. The method of claim 1, further comprising transmitting, by the STA, to the AP, a request frame requesting that the AP transmit the frame to the STA.

4. The method of claim 3, wherein transmitting, by the STA, the request frame requesting that the AP transmit the frame to the STA comprises transmitting, by the STA, one of a probe request frame, a request-to-send (RTS) frame, or a null data packet announcement (NDPA) frame.

5. The method of claim 3, wherein the frame transmitted by the AP to the STA comprises a response frame transmitted in response to the request frame transmitted by the STA, the response frame being one of a probe response frame, a clear-to-send (CTS) frame, or a null data packet (NDP) frame.

6. The method of claim 1, further comprising measuring, by the STA, an intra-basic service set (intra-BSS) RSSI based on a frame transmitted by another AP associated with the STA.

7. The method of claim 1, further comprising determining, by the STA or an associated AP, that the STA is a candidate coordinated beamforming/coordinated spatial reuse (Co-BF/Co-SR) STA.

8. The method of claim 7, further comprising transmitting, by the STA, to the associated AP, an OBSS RSSI report including the information based on the OBSS RSSI measurement, wherein the associated AP determines whether the STA is the candidate Co-BF/Co-SR STA.

9. The method of claim 7, further comprising transmitting, by the STA, to the associated AP, the information based on the OBSS RSSI by transmitting an indication whether the STA is the candidate Co-BF/Co-SR STA, wherein the STA determines that the STA is the candidate Co-BF/Co-SR STA.

10. A station (STA) not associated with an access point (AP), the STA comprising:
a transceiver; and
a processing circuit communicatively coupled with the transceiver, the processing circuit being configured to:
receive, via the transceiver, from the AP, a frame,
measure an overlapping basic service set (OBSS) received signal strength indicator (RSSI) based on the frame received from the AP; and
transmit information based on the OBSS RSSI measurement.

11. The STA of claim 10, wherein the frame comprises one of a beacon frame, a null data packet (NDP) frame, a coordinated beamforming (Co-BF) sounding response frame, or a coordinated spatial reuse (Co-SR) response frame.

12. The STA of claim 10, wherein the processing circuit is further configured to transmit, to the AP, via the transceiver, a request frame requesting that the AP transmit the frame to the STA.

13. The STA of claim 12, wherein the request frame comprises one of a probe request frame, a request-to-send (RTS) frame, or a null data packet announcement (NDPA) frame.

14. The STA of claim 10, wherein the frame comprises a response frame, the response frame being one of a probe response frame, a clear-to-send (CTS) frame, or a null data packet (NDP) frame.

15. The STA of claim 10, wherein the processing circuit is further configured to measure an intra-basic service set (intra-BSS) RSSI based on another frame transmitted by an associated AP.

16. A system comprising:
a first access point (AP1) and a second access point (AP2) communicatively coupled with the AP1, wherein:
the AP2 is configured to transmit a frame to be measured by a station (STA) not associated with the AP2; and
the AP1 is configured to receive from the STA not associated with the AP2 at least one of:
an indication that the STA is to be a candidate coordinated beamforming/coordinated spatial reuse (Co-BF/Co-SR) STA; or
an overlapping basic service set (OBSS) received signal strength indicator (RSSI) report based on the frame measured by the STA.

17. The system of claim 16, wherein the AP1 is further configured to receive the OBSS RSSI report from the STA and determine, based on the OBSS RSSI report, that the STA is the candidate Co-BF/Co-SR STA.

18. The system of claim 17, wherein the AP1 is further configured to determine that the STA is the candidate Co-BF/Co-SR STA based on an intra-basic service set (intra-BSS) report received from the STA.

19. The system of claim 16, wherein the AP1 and the AP2 are further configured to perform a Co-BF/Co-SR procedure based on at least one of the received indication that the STA is to be the candidate Co-BF/Co-SR STA or the received OBSS RSSI report.

20. The system of claim 16, wherein the frame transmitted by the AP2 to be measured by the STA comprises one of a beacon frame, a null data packet (NDP) frame, a coordinated beamforming (Co-BF) sounding response frame, or a coordinated spatial reuse (Co-SR) response frame.

21. The system of claim 16, wherein the frame transmitted by the AP2 to be measured by the STA comprises a response frame transmitted in response to a request frame transmitted by the STA, the response frame being one of a probe response frame, a clear-to-send (CTS) frame, or a null data packet (NDP) frame.
